(19) United States
(12) Patent Application Publication
(10) Pub. No.: US 2015/0362798 A1
(43) Pub. Date: Dec. 17, 2015

(54) POLARIZING PLATE AND LIQUID CRYSTAL DISPLAY INCLUDING SAME

(71) Applicant: DONGWOO FINE-CHEM CO., LTD., Iksan-si, Jeollabuk-do (KR)

(72) Inventors: Tae Chang KWON, Gyeonggi-do (KR); Yong Yeon KIM, Gyeonggi-do (KR); Min Seong CHO, Incheon (KR)

(21) Appl. No.: 14/766,450

(22) PCT Filed: Jan. 13, 2014
(86) PCT No.: PCT/KR2014/000363

§ 371 Date: Aug. 6, 2015

(30) Foreign Application Priority Data
Feb. 6, 2013 (KR) 10-2013-0013377

(51) Int. Cl. G02F 1/1335; B32B 27/08; B32B 7/12; G02B 1/14; G02B 5/30

(52) U.S. Cl. CPC G02F 1/133528; G02B 1/14; G02B 5/3033; B32B 7/12; B32B 27/08; B32B 2457/202

(57) ABSTRACT

Disclosed are a polarizing plate and a liquid crystal display device comprising the same. The polarizing plate comprises a protective film having a primer layer provided on one surface thereof; and a polarizer adhered to the primer layer through a photo-curable adhesive layer formed on the primer layer, thereby it shows superior adhesion between the polarizer and the protective film with excellent durability, while it does not need hydrophilic surface treatment in order to adhere the polarizer to the primer layer.

### BACKGROUND OF THE INVENTION

1. Field of the Invention

The present invention relates to a polarizing plate and a liquid crystal display device comprising the same.

2. Description of the Related Art

A polarizing plate is an optical part useful for a liquid crystal display device. The polarizing plate typically has a construction in which protective films are laminated on both sides of a polarizer, and is inserted in a liquid crystal display device. Although it is also known to provide a protective film on only one side of the polarizer, in most cases, a layer having alternative functions such as optical performance, which is not a simple protective film, is adhered to the other side of the polarizer, instead of using a simple protective film. A method of manufacturing a polarizer, which includes using boric acid to treat a uniaxially drawn polyvinylalcohol resin film dyed with dichroic dye; washing; and drying the same, is known and widely used in the related art.

In general, after washing and drying the polarizer, the protective films are instantly adhered to the polarizer. The reason of this is because the dried polarizer has relatively reduced physical strength, and once after winding, entails a problem of being easily torn in a processing direction. Accordingly, in general, after drying, a water-based adhesive, i.e., a polyvinylalcohol resin solution is instantly applied on the polarizer, and the protective films are simultaneously adhered to both sides of the polarizer through the adhesive. According to the common practice, a triacetylcellulose film having a thickness of 30 to 100 μm is used for the protective film.

However, both of the polyvinylalcohol film used as a polarizer and the triacetylcellulose film used as a protective film for the polarizer do not have sufficient physical properties such as heat resistance and moisture tolerance. Therefore, if the polarizing plate including the foregoing films is used under a high temperature or high humidity atmosphere over a long time, a degree of polarization is decreased, and the protective film is delaminated from the polarizer or optical properties are deteriorated. Accordingly, the polarizer with these films is largely limited in uses. Further, the triacetylcellulose film shows a significant change in existing values of an in-plane retardation (Rᵢₙ) and a thickness retardation (Rₜₕ) due to a change in surrounding temperature/humidity environments, in particular, involves a considerable change in the retardation relative to the incident light in an inclined direction. When a polarizing plate including the protective film of a triacetylcellulose film having such characteristics is employed in the liquid crystal display device, viewing angle characteristics are changed depending on the surrounding temperature/humidity environments, which in turn, cause a problem of deteriorating image quality. Further, since the triacetylcellulose film has not only a relatively large rate of dimensional change due to the change in surrounding temperature/humidity environments but also a relatively large photo elastic modulus value, changes in retardation properties may locally occur after evaluating durability under heat and/or moist heat resistant environments, thus often causing deterioration in image quality.

To overcome this problem, it is also known that amorphous polyolefin resin having lower moisture permeability than triacetylcellulose, for example, which is representative of a norbornene resin, is used for the protective film.

When a protective film made of a specific resin having low moisture permeability is adhered to a polyvinylalcohol polarizer, there are problems such as insufficient adhesive intensity in a polyvinylalcohol resin solution which is generally used as an adhesive for binding the polyvinylalcohol polarizer with triacetylcellulose, poor appearance of the prepared polarizing plate, or the like.

Korean Patent Laid-Open Publication No. 2010-97076 discloses a primer coating composition, an optical film including the same and a polarizing plate provided with the same, however, it did not propose a solution to overcome the foregoing problems.

### SUMMARY OF THE INVENTION

Accordingly, it is an object of the present invention to provide a polarizing plate with excellent adhesiveness between a polarizer and a protective film.

Another object of the present invention is to provide a polarizing plate, which does not need hydrophilic surface treatment on a primer layer.

The above object of the present invention will be achieved by the following characteristics:

(1) A polarizing plate, comprising: a protective film having a primer layer provided on one surface thereof; and a polarizer adhered to the primer layer through a photo-curable adhesive layer formed on the primer layer.

(2) The polarizing plate according to the above (1), wherein the primer layer is formed by application of a composition for forming a primer layer including a water-based resin.

(3) The polarizing plate according to the above (2), wherein the water-based resin is a water-based urethane resin prepared by reacting a compound having at least one active hydrogen in a molecule with a multivalent isocyanate compound.

(4) The polarizing plate according to the above (3), wherein the compound having at least one active hydrogen in a molecule is at least one selected from a group consisting of a low molecular weight diol compound, a polyetherdiol compound, a polyesterdiol compound, a polyetheresterdiol compound and a polycarbonatediol compound.

(5) The polarizing plate according to the above (3), wherein the multivalent isocyanate compound is at least one selected from a group of consisting of an aliphatic diisocyanate compound, an alicyclic diisocyanate compound and an aromatic isocyanate compound.

(6) The polarizing plate according to the above (1), wherein the photo-curable adhesive layer is formed by application of a photo-curable adhesive composition including a cationically polymerizable compound, a photo-polymerization initiator and a photo-sensitizer.

(7) The polarizing plate according to the above (6), wherein the cationically polymerizable compound includes an epoxy compound having at least two epoxy groups in a molecule.

(8) The polarizing plate according to the above (6), wherein the photo-polymerization initiator is an onium salt, an iron-arene complex and a mixture thereof.

(9) The polarizing plate according to the above (6), wherein the photo-sensitizer includes a compound represented by Formula 3 below:

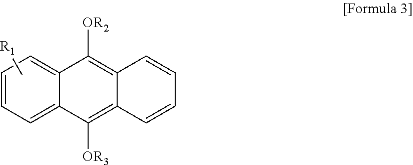

(wherein R₁ is a hydrogen atom or an alkyl group having 1 to 6 carbon atoms, and R₂ and R₃ are each independently an alkyl group having 1 to 6 carbon atoms or an alkoxyalkyl group having 2 to 12 carbon atoms).

(10) The polarizing plate according to the above (1), wherein the photo-curable adhesive layer has a thickness of 4 to 15 μm after curing.

(11) The polarizing plate according to the above (1), wherein a surface of the protective film contacting with the primer layer does not undergo surface modification.

(12) The polarizing plate according to the above (1), wherein the protective film having the primer layer has a photo elastic modulus of 1.0×10⁻¹¹/pa or less.

(13) The polarizing plate according to the above (1), wherein a surface on a side of the primer layer, to which the polarizer is adhered, does not undergo hydrophilic surface treatment.

(14) The polarizing plate according to the above (1), wherein curling (bending) is 25 mm or less.

(15) The polarizing plate according to the above (1), wherein the protective film is any one of a polyester film, cellulose film, polycarbonate film, acrylic film, styrene film, polyolefin film, polyimide film, polyethersulfone film or sulfone film.

(16) A liquid crystal display device including the polarizing plate according to any one of the above (1) to (15).

The polarizing plate of the present invention shows superior adhesion between the polarizer and the protective film.

The polarizing plate of the present invention has excellent durability to thus prevent an occurrence of deformation and shrinkage even when it is exposed under high temperature and humidity (‘hot and humid’) conditions for a long time.

The polarizing plate of the present invention does not need hydrophilic surface treatment in order to adhere the polarizer to the primer layer.

The polarizing plate of the present invention does not need surface modification of the protective film.

### BRIEF DESCRIPTION OF THE DRAWINGS

The above and other objects, features and other advantages of the present invention will be more clearly understood from the following detailed description taken in conjunction with the accompanying drawing, in which:

FIG. 1 is a cross-sectional view schematically illustrating a polarizing plate according to an embodiment of the present invention.

### DETAILED DESCRIPTION OF THE INVENTION

The present invention discloses a polarizing plate which includes a protective film having a primer layer provided on one surface thereof; and a polarizer adhered to the primer layer through a photo-curable adhesive layer formed on the primer layer, thereby it shows superior adhesion between the polarizer and the protective film with excellent durability, while it does not need hydrophilic surface treatment in order to adhere the polarizer to the primer layer, and a liquid crystal display device including the same.

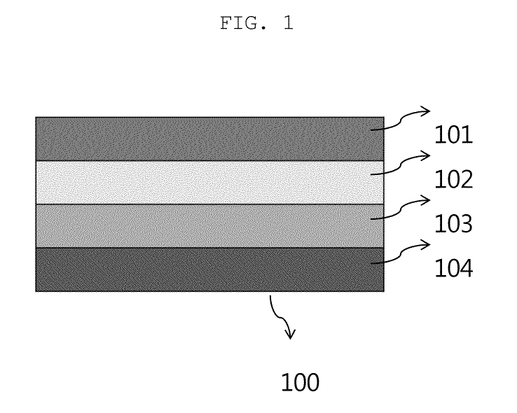

FIG. 1 is a cross-sectional view schematically illustrating a polarizing plate according to an embodiment of the present invention. Hereinafter, the present invention will be described in detail with reference to the accompanying drawing.

A polarizer 101 may be prepared by swelling, dyeing, cross-linking, stretching, washing, and drying a polarizer-formable film, which is typically used in the related art.

A protective film 104 may include any one generally used in the related art, without particular limitation thereof. It is preferable to have excellent mechanical strength, thermal stability and moisture shielding properties. It is more preferable to have excellent isotropic properties. Particular examples of the foregoing protective film may include: a polyester film such as polyethylene terephthalate, polyethylene isophthalate, polybutylene terephthalate, etc.; a cellulose film such as diacetylcellulose, triacetylcellulose, etc.; a polycarbonate film; an acrylic film such as polymethyl(meth)acrylate, polyethyl(meth)acrylate, etc.; a styrene film such as polystyrene, acrylonitrile-styrene copolymer, etc.; a polyolefin film such as polyethylene, polypropylene, a polyolefin film having a cyclo-based or norbornene structure, ethylene-propylene copolymer, etc.; a polyimide film; a polyethersulfone film; a sulfone film, or the like, and a thickness of the foregoing films is also not particularly limited. Preferably, the foregoing protective film may have isotropic properties.

A primer layer 103 may play a role of further improving adhesion between the polarizer 101 and the protective film 104, which are adhered by a photo-curable adhesive layer 102. In order to improve adhesiveness, it is necessary for a conventional protective film to undergo surface modification treatment. However, according to the present invention, it is possible to secure sufficient adhesiveness by introducing a primer layer 103 even without undergoing the above-described surface modification treatment.

The primer layer 103 may be formed by applying a composition for forming a primer layer to a surface on a side of the protective film 104, to which the polarizer 101 is adhered. The composition for forming a primer layer may include a water-based resin.

The water-based resin may include, for example, a water-based urethane resin, polyester resin and emulsion of each of these resins, and preferably, the water-based urethane resin.

Particular examples of the water-based urethane resin may include: a water-based urethane resin obtained by reacting a compound containing at least one active hydrogen in a molecule with a multivalent isocyanate compound; a water-based urethane resin obtained by conducting a urethanation reaction of a compound containing at least one active hydrogen in a molecule with a multivalent isocyanate compound in an organic solvent, which is inactivated to the reaction while having highly hydrophilic properties, in the presence of excess isocyanate groups, to produce a prepolymer containing an isocyanate group, and then, generating the water-based urethane resin from the prepolymer, or the like.

A chain extending method of the prepolymer containing an isocyanate group is not particularly limited but may include any conventional method known in the related art. For example, water, water-soluble polyamine, glycols, etc. may be used as a chain extender, and the prepolymer containing an isocyanate group may react with a chain extender component, as necessary, in the presence of a catalyst.

The compound containing at least one active hydrogen in a molecule is not particularly limited, but may be any compound having a hydroxyl group type active hydrogen and include, for example, a low molecular weight diol compound, a polyetherdiol compound, a polyesterdiol compound, a polyetheresterdiol compound, a polycarbonatediol compound, or the like.

The low molecular weight diol compound is not a polymer but a diol compound having 2 to 20 carbon atoms, and is not particularly limited but may include, for example, ethyleneglycol, propyleneglycol, diethyleneglycol, triethyleneglycol, 1,2-butyleneglycol, 1,3-butyleneglycol, 2,3-butyleneglycol, 1,4-butyleneglycol, 1,5-pentanediol, neopentylglycol, 1,6-hexaneglycol, 2,5-hexaneglycol, dipropyleneglycol, 2,2,4-trimethyl-1,3-pentanediol, 1,4-cyclohexanedimethanol, 2,2-dimethylpropanediol, 1,4-butanediol, or the like.

The polyetherdiol compound is not particularly limited but may include, for example: an alkylene oxide adduct of the foregoing diol compound; a ring opening polymer of alkylene oxide and cyclic ether (for example, tetrahydrofuran); polyethyleneglycol; polypropyleneglycol; a copolymer of etherglycol-propyleneglycol; polytetramethyleneglycol; polyhexamethyleneglycol; polyoctamethyleneglycol, or the like.

The polyesterdiol compound is not particularly limited but may include, for example, a product obtained by copolymerizing dicarboxylic acid such as adipic acid, succinic acid, sebacic acid, glutaric acid, maleic acid, fumaric acid, phthalic acid or an anhydride thereof with a diol compound in the presence of excess hydroxyl groups. More particularly, ethyleneglycol-adipic acid condensate, hexamethyhleneglycol-adipic acid condensate, ethyleneglycol-propyleneglycol-adipic acid condensate, polylactonediol formed by ring opening polymerization of lactone using glycol as an initiator, or the like, may be included.

The polyetheresterdiol compound is not particularly limited but may include, for example, a product obtained by adding a dicarboxylic acid compound or further including alkyleneoxide to an ether group-containing diol compound or a mixture of the ether group-containing diol compound and alternative glycol, then, reacting the same.

The polycarbonatediol compound is not particularly limited but may include, for example, a compound represented by Formula 1 below:

HO—R—(O—C(O)—O—R)n-OH [Formula 1]

(wherein R is a saturated fatty acid diol residue having 1 to 12 carbon atoms; and n is an integer of repeat units ranging from 5 to 50).

The multivalent isocyanate compound may be an aliphatic diisocyanate compound, cyclo-aliphatic (‘alicyclic’) diisocyanate compound or aromatic isocyanate compound containing at least one isocyanate group in a molecule, which are used alone or in combination of two or more thereof.

The aliphatic diisocyanate compound is not particularly limited but may include aliphatic diisocyanate having 1 to 12 carbon atoms, such as hexamethylene diisocyanate, 2,2,4-trimethylhexane diisocyanate, hexane diisocyanate, or the like.

The alicyclic diisocyanate compound is not particularly limited but may include alicyclic diisocyanate having 4 to 18 carbon atoms, such as 1,4-cyclohexane diisocyanate, methyl cyclohexylene diisocyanate, isophoron diisocyanate (IPDI), hexamethylene diisocyanate (HMDI), or the like.

The aromatic isocyanate compound is not particularly limited but may include, for example, trilene diisocyanate, 4,4′-diphenylmethane diisocyanate, xylene diisocyanate, or the like.

The water-based urethane resin may contain acid residue. If the water-based urethane resin contains acid residue, excellent dispersion may be achieved without using a surfactant or only using a small amount of the surfactant, thus improving water resistance of a coating film. Since a great amount of surfactant is not needed, the foregoing resin may have excellent adhesiveness to a polymer having an alicyclic structure, (meth)acrylic resin or polyester resin, and maintain high transparency.

A content of the acid residue is not particularly limited but may be included in an amount of allowing an acid value in the water-based urethane resin to be a range from 20 to 250 mg KOH/g, and preferably, from 25 to 150 mg KOH/g. When the acid value is within the above range, water resistance of the coating film as well as sufficient dispersion may be achieved.

A method of introducing the acid residue into the water-based urethane resin is not particularly limited but may include any conventional method known in the related art. For example, there is a method for introduction of a carboxyl group into polyetherdiol, polyesterdiol, polyetheresterdiol, or the like, by partially replacing the component having at least one active hydrogen in a molecule with dimethylolalkane acid. Such dimethylolalkane acid may include, for example, dimethylolacetic acid, dimethylolpropionic acid, dimethylolbutyric acid, or the like.

The water-based urethane resin may be a product of polymerization. When an acid component remaining in the resin is neutralized, water-dispersibility may be improved.

A neutralizing agent for neutralizing the acid portion may include, for example, organic amines such as trimethylamine, triethylamine, tripropylamine, tributylamine, N-methyldiethanolamine, triethanolamine, etc., or inorganic bases such as sodium hydroxide, potassium hydroxide, ammonia, etc.

A molecular weight of the water-based urethane resin is not particularly limited, however, a number average molecular weight thereof may range from 1,000 to 1,000,000, and preferably, 20,000 to 200,000.

If the primer layer 103 has a thickness of 1 μm or less, the composition for forming a primer layer may further include a cross-linking agent in order to improve a strength thereof.

Types of the cross-linking agent are not particularly limited so long as the cross-linking agent is a compound having a functional group reactable with the water-based resin, and may include, for example, a water-based epoxy compound, water-based amino compound, water-based isocyanate compound, water-based carbodiimide compound and water-based oxazoline compound. In view of improvement in adhesiveness, the water-based epoxy compound, water-based amino compound or water-based oxazoline compound may be used.

The water-based epoxy compound is not particularly limited so long as it is soluble in water or has at least two emulsified epoxy groups, and may include, for example: a diepoxy compound obtained by etherification of 1 mole of glycol such as ethyleneglycol, diethyleneglycol, triethyleneglycol, polyestyleneglycol, propyleneglycol, dipropyleneglycol, 1,4-butandiol, 1,6-hexaneglycol, neopentylglycol, etc. with 2 moles of epichlorohydrin; a polyepoxy compound obtained by etherification of 1 mole of polyhydric alcohol such as glycerin, polyglycerin, trimethylolpropane, pentaerythritol, sorbitol, etc. with at least 2 moles of epichlorohydrin; a diepoxy compound obtained by esterification of 1 mole of dicarboxylic acid such as phthalic acid, terephthalic acid, oxalic acid, adipic acid, etc. with 2 moles of epichlorohydrin, or the like.

The water-based amino compound is not particularly limited so long as it is soluble in water or has at least two emulsified amino groups, and may include, for example: hydrazide compounds such as carbodihydrazide, oxalic acid dihydrazide, malonic acid dihydrazide, succinic acid dihydrazide, adipic acid dihydrazide, sebacic acid dihydrazide, lauric acid dihydrazide, isophthalic acid dihydrazide, terephthalic acid dihydrazide, glycolic acid dihydrazide, polyacrylic acid dihydrazide, etc.; melamine resin; urea resin; guanamine resin, or the like.

The water-based isocyanate compound is not particularly limited so long as it is soluble in water or has at least two emulsified non-block type isocyanate groups or block type isocyanate groups.

The non-block type isocyanate compound is not particularly limited but may include, for example, a compound obtained by reacting a multi-functional isocyanate compound with mono- or multivalent nonionic polyalkylene ether alcohol.

The block type isocyanate compound is not particularly limited but may include, for example, 2,4-trilene diisocyanate, 2,6-trilene diisocyanate, 4,4-diphenylmethane diisocyanate, xylene diisocyanate, isophorone diisocyanate, methylcyclohexyl diisocyanate, 4,4-dicyclohexylmethane diisocyanate, 1,3-bis(isocyanatemethyl)cyclohexane, tetramethylxylene diisocyanate, 2,2,4-trimethylhexamethylene diisocyanate, hexamethylene diisocyanate, norbornene diisocyanate, 2,4,6-triisopropylphenyl diisocyanate, 1,12-dodecane diisocyanate, 2,4-bis-(8-isocyanateoctyl)-1,3-dioctylcyclobutane, n-pentane-1,4-diisocyanate and isocyanurate modified bodies, adduct modified bodies, burette modified bodies or allophanate modified bodies thereof; a compound which is obtained by modifying a polymer having at least one isocyanate group formed through polymerization of at least one among the foregoing compounds to have a polyoxyalkylene or carboxyl group; and making it to be water-soluble or water-dispersible, and masking the isocyanate group with a blocking agent (phenol, ε-caprolactam, etc.), or the like.

The water-based carbodiimide compound is not particularly limited so long as it is soluble in water or has at least two emulsified carbodiimide bonds (—N═C═N—).

The compound having at least two carbodiimide bonds may be obtained by a process of using two molecules or more of polyisocyanate and a catalyst for formation of carbodiimide to conduct decarbonation of two isocyanate groups, so as to form the bond ‘—N═C═N—.’ The polyisocyanate and the catalyst for formation of carbodiimide used for preparing a compound having at least two carbodiimide bonds are not particularly limited but may include any conventional compound used in the related art.

The water-based oxazoline compound is not particularly limited so long as it is soluble in water or has at least two or more emulsified oxazoline groups.

A content of the cross-linking agent is not particularly limited but, for example, may range from 1 to 70 parts by weight (‘wt. parts’), and preferably, 5 to 60 wt. parts to a total 100 wt. parts of the water-based resin in terms of solid content. When the content of the cross-linking agent is within the above range, a desired strength of the coating film and stability of a coating solution may be achieved.

Optionally, the composition for forming a primer layer may further include any additive such as heat resistant stabilizers, weather-proof stabilizers, leveling agents, antistatic agents, slipping agents, anti-blocking agents, anti-fog agents, lubricants, dyes, pigments, natural oil, synthetic oil, wax, cross-linking agents, or the like.

Water-based resin particles dispersed into a water-dispersion of the water-based resin may have a particle diameter of 0.01 to 0.4 μm in view of optical characteristics. The particle diameter of the water-based resin particles may be measured by dynamic dispersion of light, for example, using a light scattering photometer DLS-8000 series manufactured by Otsuka Electronics Co., Ltd.

The composition for forming a primer layer may include a water-soluble solvent.

The water-soluble solvent is not particularly limited but may include, for example, methanol, ethanol, isopropyl alcohol, acetone, tetrahydrofuran, N-methyl pyrrolidone, dimethyl sulfoxide, ethyleneglycol monomethylether, ethyleneglycol monobutylether, or the like.

A viscosity of the composition for forming a primer layer is not particularly limited but may be 15 mPa·s or less, and preferably, 10 mPa·s or less. When the viscosity of the composition for forming a primer layer is within the above range, the primer layer may be uniformly applied.

A method of controlling the viscosity of the composition for forming a primer layer is not particularly limited but may include, for example, varying a content of the water-based resin or a particle diameter of the water-based resin particles.

A hardness of the primer layer 103 is not particularly limited but may be a pencil hardness of H or higher at a thickness of 20 μm. When the hardness is within the above range, anti-abrasive properties may be ensured.

A method of applying the composition for forming a primer layer is not particularly limited but may use any conventional method known in the related art, for example, wire-bar coating, dipping, spray coating, spin coating, roll coating, gravure coating, air-knife coating, curtain coating, slide coating, or the like.

A coating thickness of the composition for forming a primer layer is not particularly limited but, for example, a thickness after drying may range from 0.01 to 5 μm, preferably, from 0.02 to 2 μm, and more preferably, from 0.03 to 1 μm. When the coating thickness of the composition for forming a primer layer is within the above range, a sufficient adhesion intensity to the polarizer 101 may be obtained.

It is preferable that the protective film 104 and the primer layer 103 has a difference in interfacial refractive indexes of 0.05 or less therebetween. When the difference in interfacial refractive indexes is within the above range, light loss may be prevented during light penetration.

For the protective film 104 provided with the primer layer 103, a photo elastic modulus is not particularly limited but, for example, may be 1.0×10⁻¹¹/pa or less, and preferably, range from 1.0×10⁻¹²/pa to 7.0×10⁻¹²/pa. When the photo elastic modulus is within the above range, shrinkage and expansion of the polarizing plate 100 may be controlled, and when the polarizing plate is applied to a liquid crystal panel or the like, light leakage may be considerably reduced.

A photo-curable adhesive layer 102 may be formed by application of a photo-curable adhesive composition.

The photo-curable adhesive composition may be applied onto the primer layer 103 or a surface of the polarizer 101 to which the primer layer 103 is adhered. A method for application of the photo-curable adhesive composition is not particularly limited but may include any conventional method used in the related art.

The photo-curable adhesive composition according to the present invention may include a cationically polymerizable compound, a photo-polymerization initiator, a photo-sensitizer, or the like.

The cationically polymerizable compound is a major component of the photo-curable adhesive composition to provide adhesiveness by polymerization curing.

The cationically polymerizable compound is not particularly limited but may include, for example, an epoxy compound having at least two epoxy groups in a molecule.

The epoxy compound may include, for example: an aromatic epoxy compound having an aromatic ring in a molecule; an aliphatic epoxy compound having no aromatic ring in a molecule but a ring (usually an ‘oxyrane ring’) containing an epoxy group and two carbon atoms bonded thereto, wherein one of the carbon atoms is bonded to an alternative aliphatic carbon atom; or the like. The epoxy compound is preferably an aromatic epoxy compound having an aromatic ring in a molecule, an alicyclic epoxy compound, or a mixture thereof.

When using the aromatic epoxy compound having an aromatic ring in a molecule, moisture permeability of the photo-curable adhesive may decrease to inhibit a change due to inflow of moisture, thus improving durability of the polarizing plate 100. On the other hand, when using an alicyclic epoxy compound, a cured material having a high storage elastic modulus may be provided, and for the polarizing plate 100 in which the protective film 104 and the polarizer 101 are adhered to each other through the cured material (adhesive layer), it is rare for the polarizer 101 to be broken.

The aromatic epoxy compound having an aromatic ring in a molecule may include, for example, bisphenol type epoxy resins, and more particularly, bisphenol A epoxy resin, bisphenol F epoxy resin, bisphenol AD epoxy resin, novolac epoxy resin, naphthalene type epoxy resin, trisphenolmethane type epoxy resin, glycidylamine type epoxy resin, or the like.

The bisphenol type epoxy resin products commercially available in the market may include, for example: epiclon 840, epiclon 840-S, epiclon 850, epiclon 850-S, epiclon 850-CRP, epiclon 830, epiclon 830-S, epiclon 830-LVP, epiclon 835, epiclon N-660, epiclon N-740, epiclon HP-820, epiclon HP-4032 and epiclon EXA-7015, which are manufactured by Dainippon ink & chemicals; EP-4080S, EP-4085S, EP-4080 and EP-4000S, which are manufactured by Asahi Denka Co.; EX-212L, EX-214L, EX-216L, EX-321L and EX-850L, which are manufactured by Nagase Chemtex; YD-128, YDF-134 and YDF-8170, which are manufactured by Gukdo Chemicals, or the like.

The bisphenol type epoxy resin used herein may have a viscosity ranging from 1,000 to 50,000 cps.

The alicyclic epoxy compound has at least two epoxy groups in a molecule wherein at least one of the epoxy groups is bonded to an alicyclic ring, and may have a structure represented by Formula 2 below:

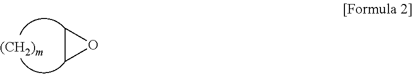

(wherein m is an integer of 2 to 5).

A compound in which a group having a form of removing one or a plurality of hydrogen atoms among (CH₂)ₘ in Formula 2 is bonded to another chemical structure may be the alicyclic epoxy compound. Hydrogen forming the alicyclic ring may be appropriately substituted by a straight alkyl group such as a methyl or ethyl group. Among these, a compound having an epoxy cyclopentane ring or epoxy cyclohexane ring is preferably used.

Among the alicyclic epoxy compounds, a compound represented by any one of Formulae 1 to 11 below is more preferably used due to their being easily available and a large effect of increasing storage elastic modulus of the cured material.

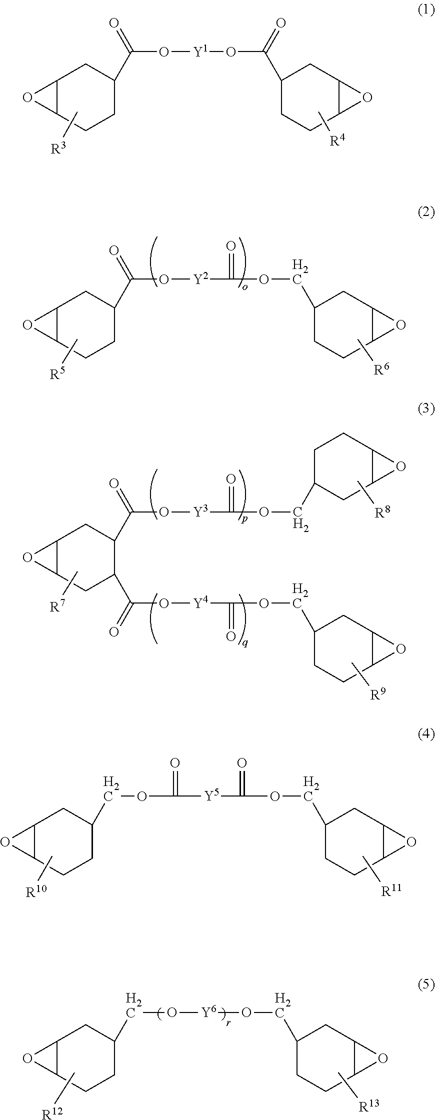

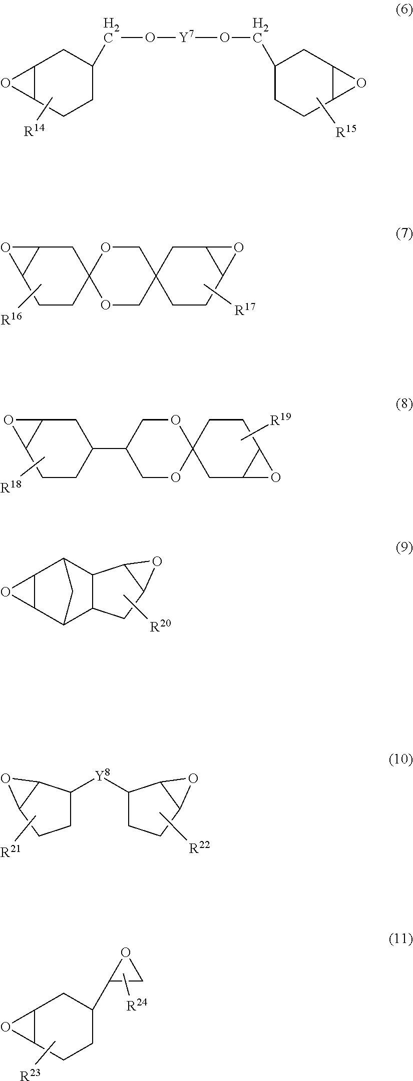

(wherein R₃ to R₂₄ denote each independently a hydrogen atom or an alkyl group having 1 to 6 carbon atoms, and when the R₃ to R₂₄ are the alkyl group, a position to be bonded to the alicyclic ring is any one of a first position to sixth position. The alkyl group having 1 to 6 carbon atoms may be a straight chain, may have a branch or may have an alicyclic ring. Y⁸ denotes an oxygen atom or an alkanediyl group having 1 to 20 carbon atoms, Y¹ to Y⁷ denote an alkanediyl group which has 1 to 20 carbon atoms and may also be each independently a straight chain, may also have a branch or may also have an alicyclic ring, and n, p, q and r denote each independently an integer of 0 to 20).

Among the compounds represented by the above Formulae 1 to 11, an alicyclic diepoxy compound represented by Formula 2 is preferably used due to its being easily available. The alicyclic diepoxy compound represented by Formula 2 is an esterified material of 3,4-epoxycyclohexyl methanol (having a cyclohexane ring to which an alkyl group having 1 to 6 carbon atoms may be bonded) with 3,4-epoxycyclohexane carboxylic acid (having a cyclohexane ring to which an alkyl group having 1 to 6 carbon atoms may be bonded). For example, the alicyclic diepoxy compound represented by Formula 2 may include 3,4-epoxycyclohexylmethyl 3,4-epoxycyclohexane carboxylate, 3,4-epoxy-6-methyl cyclohexylmethyl, 3,4-epoxy-6-methyl cyclohexane carboxylate, or the like.

In addition, the cationically polymerizable compound may further include the compound having a ring (usually an ‘oxyrane ring’) containing an epoxy group and two carbon atoms bonded thereto, wherein one of the carbon atoms is bonded to an alternative aliphatic carbon atom. The compound plays a role of further improving the adhesion between the polarizer 101 and the protective film 104, while maintaining the storage elastic modulus of the cured material at a high value.

An example of the above-described compound may include polyglycidylether of aliphatic polyhydric (phenol). Among these, a polyglycidylether compound represented by Formula 12 below is preferably used due to its being easily available and a large effect of increasing the adhesion between the polarizer 101 and the protective film 104.

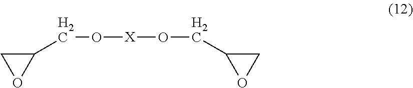

(wherein X denotes a direct bond, a methylene group, an alkylidene group having 1 to 4 carbon atoms, an alicyclic hydrocarbon group, O, S, SO₂, SS, SO, CO, OCO, or a substituent selected from a group consisting of three substituents represented by the following formulae, and the alkylidene group may also be substituted by a halogen atom).

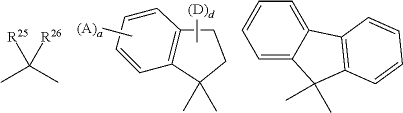

(wherein R₂₅ and R₂₆ are each independently a hydrogen atom; an alkyl group having 1 to 3 carbon atoms; or a phenyl group which may be substituted by an alkyl or alkoxy group having 1 to 10 carbon atoms or a cyclo alkyl group having 3 to 10 carbon atoms, or R₂₅ and R₂₆ may be connected to each other to form a ring; and

A and D denote each independently an alkyl group having 1 to 10 carbon atoms which may be substituted by an alkyl group, an aryl having 6 to 20 carbon atoms which may also be substituted by a halogen atom, an arylalkyl group having 7 to 20 carbon atoms which may also be substituted by a halogen atom, a heterocyclic group having 2 to 20 carbon atoms which may also be substituted by a halogen atom or a halogen atom; and the methylene group of the alkyl, aryl, or arylalkyl group may be an unsaturated bond, or may also be disconnected by —O— or —S—, and a and d are each independently an integer of 0 to 4).

The diglycidylether compound represented by Formula 12 may include, for example, multi-functional epoxy resin such as glycidylether of tetrahydroxyphenylmethane, glycidylether of tetrahydroxybenzophenone, epoxidized polyvinylphenol, etc.; polyglycidylether of aliphatic polyhydric alcohol; polyglycidylether of alkyleneoxide adduct of aliphatic polyhydric alcohol; diglycidylether of alkyleneglycol, or the like.

The aliphatic polyhydric alcohol may include, for example: aliphatic diols such as ethyleneglycol, 1,2-propanediol, 1,3-propanediol, 2-methyl-1,3-propanediol, 2-butyl-2-ethyl-1,3-propanediol, 1,4-butanediol, neopentylglycol, 3-methyl-2,4-pentanediol, 2,4-pentanediol, 1,5-pentanediol, 3-methyl-1,5-pentanediol, 2-methyl-2,4-pentanediol, 2,4-diethyl-1,5-pentanediol, 1,6-hexanediol, 1,7-hetanediol, 3,5-hetanediol, 1,8-octanediol, 2-methyl-1,8-octanediol, 1,9-nonanediol, 1,10-decanediol, etc.; alicyclic diols such as cyclohexanedimethanol, cyclohexanediol, etc.; trivalent or more polyols such as trimethylolethane, trimethylolpropane, hexitols, pentitols, glycerin, polyglycerin, pentaerythritol, dipentaerythritol, tetramethylolpropane, etc.

A content of the cationically polymerizable compound is not particularly limited but, for example, may range from 70 to 99% by weight (‘wt. %’), and preferably, 90 to 99 wt. % to a total weight of the photo-curable adhesive composition. When the content of the cationically polymerizable compound is within the above range, excellent hardness may be achieved and yellowing may be inhibited.

A mixing ratio of the aromatic epoxy compound having an aromatic ring in a molecule to the alicyclic epoxy compound is not particularly limited but, for example, may range from 8:2 to 5:5, and preferably, 7:3 to 6.5:3.5. When the mixing ratio is within the above range, reactivity may be improved to thus increase a cross-linking density.

The cationically polymerizable compound according to the present invention may further include a conventional cationically polymerizable compound used in the related art without departing from the scope of the present invention.

The photo-polymerization initiator generates cationic species or Lewis acid by radiation of active energy beam such as visible light, UV ray, X-ray, electronic beam, etc. to initiate polymerization reaction of the cationically polymerizable compound. The photo-polymerization initiator acts catalytically to light, thereby ensuring excellent storage stability or workability even if it is mixed with the cationically polymerizable compound.

Types of the photo-polymerization initiator are not particularly limited but may include, for example: aromatic diazonium salts; onium salts such as aromatic iodonium salts or aromatic sulfonium salts; iron-arene complexes, or the like, which are used alone or in combination of two or more thereof.

The aromatic diazonium salts may include, for example, benzenediazonium hexafluoroantimonate, benzenediazonium hexafluorophosphate, benzenediazonium hexafluoroborate, or the like.

The aromatic iodonium salts may include, for example, diphenyliodonium tetrakis(pentafluorophenyl)borate, diphenyliodonium hexafluorophosphate, diphenyliodonium hexafluoroantimonate, di(4-nonylphenyl)iodonium hexafluorophosphate, or the like. The aromatic sulfonium salts may include, for example, triphenylsulfonium hexafluorophosphate, triphenylsulfonium hexafluoroantimonate, triphenylsulfonium tetrakis(pentafluorophenyl)borate, 4,4′-bis[diphenylsulfonio]diphenylsulfide bishexafluorophosphate, 4,4′-bis[di(β-hydroxyethoxy)phenylsulfonio]diphenylsulfide bishexafluoroantimonate, 4,4′-bis[di((3-hydroxyethoxy)phenylsulfonio]diphenylsulfide bishexafluorophosphate, 7-[di(p-toluyl)sulfonio]-2-isopropylthioxanthone hexafluoroantimonate, 7-[di(p-toluyl)sulfonio]-2-isopropylthioxanthone tetrakis(pentafluorophenyl)borate, 4-phenylcarbonyl-4′-diphenylsulfonio-diphenylsulfide hexafluorophosphate, 4-(p-tert-butylphenylcarbonyl)-4′-diphenylsulfonio-diphenyl sulfide hexafluoroantimonate, 4-(p-tert-butylphenylcarbonyl)-4′-di(p-toluyl)sulfonio-diphenylsulfide tetrakis(pentafluorophenyl)borate, or the like.

The iron-arene complexes may include, for example, xylene-cyclopentadienyl iron(II) hexafluoroantimonate, cumene-cyclopentadienyl iron(II) hexafluorophosphate, xylene-cyclopentadienyl iron(II) tris(trifluoromethylsulfonyl)methanide, or the like.

Among the foregoing materials, the aromatic sulfonium salt is preferably used since it has UV absorption properties even in a wavelength region near 300 nm to thus exhibit excellent curable properties and can provide a cured material having favorable mechanical strength or adhesive strength.

A content of the photo-polymerization initiator is not particularly limited but, for example, may range from 1 to 10 wt. parts, and preferably, 2 to 6 wt. parts to 100 wt. parts of the cationically polymerizable compound. When the content of the photo-polymerization initiator is within the above range, the cationically polymerizable compound may be sufficiently cured and the polarizing plate 100 prepared by using the same may have high mechanical strength and adhesive strength.

The photo-polymerization initiator according to the present invention may further include a conventional photo-polymerization initiator used in the related art without departing from the scope of the present invention.

The photo-sensitizer is a component to improve curing properties of the adhesive composition and may exhibit maximum absorption for a light having a longer wavelength than 380 nm.

The photo-sensitizer according to the present invention may include a compound represented by Formula 3 below:

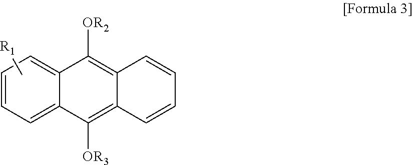

(wherein R₁ is a hydrogen atom or an alkyl group having 1 to 6 carbon atoms, and R₂ and R₃ are each independently an alkyl group having 1 to 6 carbon atoms or an alkoxyalkyl group having 2 to 12 carbon atoms).

Types of the photo-sensitizer are not particularly limited but may include, for example, 9,10-dimethoxyanthracene, 9,10-diethoxyanthracene, 9,10-dipropoxyanthracene, 9,10-diisopropoxyanthracene, 9,10-dibutoxyanthracene, 9,10-dipentyloxyanthracene, 9,10-dihexylocyanthracene, 9,10-bis(2-methoxyethoxy)anthracene, 9,10-bis(2-ethoxyethoxy)anthracene, 9,10-bis(2-butoxyethoxy)anthracene, 9,10-bis(3-butoxypropoxy)anthracene, 2-methyl or 2-ethyl-9,10-dimethoxyanthracene, 2-methyl or 2-ethyl-9,10-diethoxyanthracene, 2-methyl or 2-ethyl-9,10-dipropoxyanthracene, 2-methyl or 2-ethyl-9,10-diisopropoxyanthracene, 2-methyl or 2-ethyl-9,10-dibutoxyanthracene, 2-methyl or 2-ethyl-9,10-dipentyloxyanthracene, 2-methyl or 2-ethyl-9,10-dihexyloxyanthracene, or the like.

A content of the photo-sensitizer is not particularly limited but, for example, may range from 0.1 to 2 wt. parts to 100 wt. parts of the cationically polymerizable compound, and in view of maintaining neutral grey color of the polarizing plate 100, the content thereof preferably ranges from 0.1 to 0.5 wt. parts, and more preferably, from 0.1 to 0.3 wt. parts.

The photo-sensitizer according to the present invention may further include a conventional photo-sensitizer used in the related art without departing from the scope of the present invention.

The photo-curable adhesive composition according to the present invention may further include a photo-sensitization supporter represented by Formula 4 below. The photo-sensitization supporter is a component to improve curing properties of the adhesive composition.

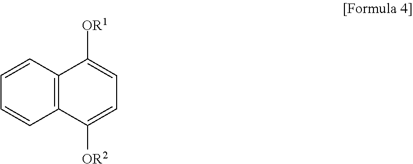

(wherein R₁ and R₂ are each independently an alkyl group having 1 to 6 carbon atoms).

Types of the photo-sensitization supporter are not particularly limited but may include, for example, 1,4-dimethoxynaphthalene, 1-ethoxy-4-methoxynaphthalene, 1,4-diethoxynaphthalene, 1,4-dipropoxynaphthalene, 1,4-dibutoxynaphthalene, or the like.

A content of the photo-sensitization supporter is not particularly limited but, for example, may range from 0.1 to 10 wt. parts, and preferably, 0.1 to 5 wt. parts to 100 wt. parts of the cationically polymerizable compound. When the content of the photo-sensitization supporter is within the above range, effects of improving curing properties may be maximized.

The photo-curable adhesive composition may further include any additive such as thermal polymerization initiators, ion trappers, antioxidants, light stabilizers, chain transfer agents, adhesion promoters, thermo-plastic resins, fillers, flow control agents, plasticizers, defoaming agents, leveling agents, pigments, organic solvents, or the like. A content of the additive may be 10 wt. parts or less to 100 wt. parts of the cationically polymerizable compound.

The polarizer 101 may be adhered on the primer layer 103 through the photo-curable adhesive layer 102 formed by application of the photo-curable adhesive composition.

When adhering the polarizer 101 by the conventional water-based adhesive, hydrophilic surface treatment such as corona discharging, plasma treatment, sensitization, UV irradiation, or the like is required to increase hydrophilic properties of the primer layer to thus improve adhesion between the primer layer 103 and the polarizer 101. Accordingly, there is a problem of deteriorating the manufacturing process efficiencies such as time, costs, etc.

However, the present invention adopts the photo-curable adhesive layer 102 to adhere the polarizer 101, therefore, can exhibit excellent adhesiveness even without any hydrophilic surface treatment, while having excellent durability under a hot and humid condition.

A thickness of the photo-curable adhesive layer 102 is not particularly limited but, for example, a thickness after curing may range from 4 to 15 μm, and preferably, from 8 to 12 μm. When the thickness of the photo-curable adhesive layer 102 is within the above range, effects of improving adhesiveness and durability of the polarizing plate 100 may be maximized.

The polarizing plate 100 of the present invention having the above-described configuration may exhibit improved durability. For example, when the polarizing plate 100 is left under conditions of 25° C. and a relative humidity of 50% for 24 hours, curling (bending) of the polarizing plate is about 25 mm or less. According to the present invention, curling (bending) of the polarizing plate 100 refers to a height from the bottom to a point most far from the same when the polarizing plate 100 was placed on a flat floor.

The polarizing plate 100 may further include a protective film on a surface opposed to the surface of the polarizer 101 to which the primer layer 103 is adhered.

The foregoing protective film may be substantially the same as the protective film 104 having the primer layer 103.

The polarizing plate 100 of the present invention may further include an adhesive layer at the bottom of the protective film 104, in order to bind the same to the liquid crystal panel or the like.

Such an adhesive layer may be formed by application of any conventional adhesive used in the related art.

The foregoing polarizing plate 100 may be applicable to any conventional liquid crystal display device, and more particularly, it is possible to manufacture a liquid crystal display device including a liquid crystal panel, wherein the polarizing plate 100 having an adhesive layer laminated thereon is adhered to at least one surface of a liquid crystal cell in the liquid crystal panel.

Hereinafter, preferred embodiments will be described to more concretely understand the present invention with reference to examples. However, it will be apparent to those skilled in the related art that such embodiments are provided for illustrative purposes without limitation of appended claims, various modifications and alterations may be possible without departing from the scope and spirit of the present invention, and such modifications and alterations are duly included in the present invention as defined by the appended claims.

### EXAMPLE

### Example 1

### (1) Preparation of Photo-Curable Adhesive Composition

By mixing 65 wt. parts of CEL-2021P (Daicel Chemicals) and 32 wt. parts of YDF-8170 (Gukdo Chemicals) as cationically polymerizable compounds, 2.0 wt. parts of CPI-110A as a photo-polymerization initiator and 1.0 wt. parts of UVS-1331 (Cheon-gyo Chemical Industry Co. Ltd.) as a photo-sensitizer, a photo-curable adhesive composition was prepared.

### (2) Manufacturing of Polarizing Plate

A triacetylcellulose film was adhered to a top face of a polyvinylalcohol polarizer.

Then, using the foregoing photo-curable adhesive composition, a laminate having a primer layer formed on a cycloolefin film (zeonor film: eZB1, Zeon Co.) was adhered to a polarizer.

### Example 2

A polarizing plate was manufactured according to the same procedures as described in Example 1, except that an adhesive composition including 98 wt. % of trimethylolpropane triacrylate (Aronixs M-309, Toagosei Co., Ltd.) as a cationically polymerizable compound, 1.0 wt. % of UVACURE 1590 (DAICEL-CYTEC Company) as a photo-polymerization initiator, and 1.0 wt. % of IRGACURE 184 (CIBA Co.) as a photo-sensitizer was used instead of the above photo-curable adhesive.

### Comparative Example 1

A polarizing plate was manufactured according to the same procedures as described in Example 1, except that a cycloolefin film having no primer layer formed thereon was adhered to a polarizer.

### Comparative Example 2

A polarizing plate was manufactured according to the same procedures as described in Example 1, except that an adhesive composition including 3 wt. % of polyvinylalcohol resin Z-200 (Japan Synthetic Chemistry), 1 wt. % of a cross-linking agent (glyoxylic acid salt SPM-01, Japan Synthetic Chemistry) and 96 wt. % of water was used instead of the above photo-curable adhesive.

### Comparative Example 3

A polarizing plate was manufactured according to the same procedures as described in Example 1, except that a cycloolefin film having no primer layer formed thereon was adhered to a polarizer by the adhesive composition used in Comparative Example 2.

### Comparative Example 4

A polarizing plate was manufactured according to the same procedures as described in Example 1, except that a cycloolefin film having no primer layer formed thereon was adhered to a polarizer by the adhesive composition used in Example 2.

### Experimental Example

### (1) Evaluation of Adhesiveness

According to the following standards, adhesion between the polarizer and the protective film was evaluated for each of the polarizing plates manufactured in Examples and Comparative Examples, and results thereof are shown in Table 1 below.

◯: no film development occurs by carving but film is broken without delamination of an interface

Δ: no film breaking occurs by carving but delamination occurs at the interface

X: film is easily detached by carving and separation, lifting occurs between the protective film and the polarizer

### (2) Evaluation of Moist Heat Resistance, Heat Resistance and Thermal Impact Resistance

Each of the polarizing plates manufactured in Examples and comparative Examples was placed in a moist heat resistant oven at a temperature of 60° C. and a relative humidity of 90% and a heat resistant oven at a temperature of 80° C., respectively, followed by leaving the same therein for 3 hours as it is. Thereafter, appearance of the polarizing plates was evaluated according to the following standards.

Meanwhile, each of the polarizing plates manufactured in Examples and Comparative Examples was subjected to a thermal impact test. The thermal impact test was repeated 100 times and for 1 hour at each time, which includes: placing the polarizing plate in an H/S oven; and raising a temperature from −40° C. to 90° C., then, dropping it to −40° C. again. Thereafter, appearance of the polarizing plates was evaluated according to the following standards.

◯: deformation and shrinkage of the polarizing plate were not observed and yellowing did not occur

Δ: the polarizer and protective film were not completely adhered to each other but separated, thus observing partial lifting

x: occurrence of significant lifting between the polarizer and the protective film allowed separation thereof by carving the lifting part, and yellowing occurred.

TABLE 1

| | | | | Thermal |
|---|---|---|---|---|
| | | Heat | Moist heat | impact |
| Item | Adhesiveness | resistance | resistance | resistance |
| Example 1 | ◯ | ◯ | ◯ | ◯ |
| Example 2 | ◯ | ◯ | Δ | ◯ |
| Comparative | X | ◯ | ◯ | ◯ |
| Example 1 | | | | |
| Comparative | ◯ | Δ | X | ◯ |
| Example 2 | | | | |
| Comparative | Δ | X | X | X |
| Example 3 | | | | |
| Comparative | Δ | Δ | X | X |
| Example 4 | | | | |

Referring to Table 1, the polarizing plate stated in Example 1 exhibited excellent adhesiveness and excellent heat resistance, moist heat resistance and thermal impact resistance, thereby involving no occurrence of deformation even when it was exposed to a hot and humid condition and a thermal impact condition. For Example 2, heat and moist resistance was slightly deteriorated due to use of an acrylate-based photo-curable adhesive composition.

However, it was demonstrated that the polarizing plates stated in Comparative Examples 1 to 4 exhibited deteriorated adhesiveness, or a decrease in heat resistance, heat and moist resistance or thermal impact resistance, hence causing a problem such as delamination of a polarizer from a protective film under a hot and humid condition, and a thermal impact condition.

1. A polarizing plate, comprising:
a protective film having a primer layer provided on one surface thereof; and
a polarizer adhered to the primer layer through a photo-curable adhesive layer formed on the primer layer.

2. The polarizing plate according to claim 1, wherein the primer layer is formed by application of a composition for forming a primer layer including a water-based resin.

3. The polarizing plate according to claim 2, wherein the water-based resin is a water-based urethane resin prepared by reacting a compound having at least one active hydrogen in a molecule with a multivalent isocyanate compound.

4. The polarizing plate according to claim 3, wherein the compound having at least one active hydrogen in a molecule is at least one selected from a group consisting of a low molecular weight diol compound, a polyetherdiol compound, a polyesterdiol compound, a polyetheresterdiol compound and a polycarbonatediol compound.

5. The polarizing plate according to claim 3, wherein the multivalent isocyanate compound is at least one selected from a group of consisting of an aliphatic diisocyanate compound, an alicyclic diisocyanate compound and an aromatic isocyanate compound.

6. The polarizing plate according to claim 1, wherein the photo-curable adhesive layer is formed by application of a photo-curable adhesive composition including a cationically polymerizable compound, a photo-polymerization initiator and a photo-sensitizer.

7. The polarizing plate according to claim 6, wherein the cationically polymerizable compound includes an epoxy compound having at least two epoxy groups in a molecule.

8. The polarizing plate according to claim 6, wherein the photo-polymerization initiator is an onium salt, an iron-arene complex and a mixture thereof.

9. The polarizing plate according to claim 6, wherein the photo-sensitizer includes a compound represented by Formula 3 below: 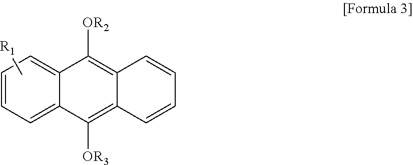
(wherein R1 is a hydrogen atom or an alkyl group having 1 to 6 carbon atoms, and R2 and R3 are each independently an alkyl group having 1 to 6 carbon atoms or an alkoxyalkyl group having 2 to 12 carbon atoms).

10. The polarizing plate according to claim 1, wherein the photo-curable adhesive layer has a thickness of 4 to 15 μm after curing.

11. The polarizing plate according to claim 1, wherein a surface of the protective film contacting with the primer layer does not undergo surface modification treatment.

12. The polarizing plate according to claim 1, wherein the protective film having the primer layer has a photo elastic modulus of 1.0×10-11/pa or less.

13. The polarizing plate according to claim 1, wherein a surface on a side of the primer layer, to which the polarizer is adhered, does not undergo hydrophilic surface treatment.

14. The polarizing plate according to claim 1, wherein curling (bending) is 25 mm or less.

15. The polarizing plate according to claim 1, wherein the protective film is any one of a polyester film, cellulose film, polycarbonate film, acrylic film, styrene film, polyolefin film, polyimide film, polyethersulfone film or sulfone film.

16. A liquid crystal display device comprising the polarizing plate according to claim 1.
